(19) United States
(12) Patent Application Publication
(10) Pub. No.: US 2022/0076146 A1
(43) Pub. Date: Mar. 10, 2022

(54) YIELD RATE PREDICTION METHOD, YIELD RATE PREDICTION SYSTEM AND MODEL TRAINING DEVICE OF SEMICONDUCTOR MANUFACTURING PROCESS

(71) Applicant: UNITED MICROELECTRONICS CORP., Hsinchu (TW)

(72) Inventor: Shih-Fang HONG, Tainan City (TW)

(21) Appl. No.: 17/072,073

(22) Filed: Oct. 16, 2020

(30) Foreign Application Priority Data
Sep. 7, 2020 (CN) 202010927456.8

(51) Int. Cl. G06N 5/04; G06N 20/00

(52) U.S. Cl. CPC G06N 5/04; G06N 20/00

(57) ABSTRACT

A yield rate prediction method, a yield rate prediction system, and a model training device of a semiconductor manufacturing process are provided. The yield rate prediction method of a semiconductor manufacturing process includes the following steps. A correspondence relation between a circuit path of a netlist and an integrated circuit layout is established. Several defective points on several stacking layers are obtained. A recognition model is trained to recognize a fault occurred on the circuit path according to the defective points. A probability of the fault occurred on the circuit path of a semiconductor semi-final product according to the recognition model is recognized. A yield rate of the semiconductor semi-final product is predicted according to the probability.

This application claims the benefit of People's Republic of China application Serial No. 202010927456.8, filed Sep. 7, 2020, the subject matter of which is incorporated herein by reference.

### BACKGROUND OF THE INVENTION

### Field of the Invention

The invention relates in general to a yield rate prediction method, a yield rate prediction system and a model training device, and more particularly to a yield rate prediction method, a yield rate prediction system and a model training device of a semiconductor manufacturing process.

### Description of the Related Art

Along with the advance in technology, various semiconductor devices are provided one after another. As the internal circuit design of the semiconductor device is getting more and more complicated, the semiconductor manufacturing process also becomes complicated. A chip may take up to thousands of processes to complete. Once defect occurs at any of the processes, the chip or the wafer may become scrapped.

Generally speaking, after a semiconductor device is manufactured, the semiconductor plant needs to perform electrical testing on the semiconductor device to check if any functional errors exist. However, since the electrical testing step is performed after the semiconductor device is already manufactured, the sunk cost and time cannot be recovered.

### SUMMARY OF THE INVENTION

The invention is directed to a yield rate prediction method, a yield rate prediction system and a model training device of a semiconductor manufacturing process for recognizing semi-final products during the semiconductor manufacturing process using a recognition model. Once a defective point is detected during a semiconductor manufacturing process, the probability of the final product having functional errors can immediately be predicted. Thus, the yield rate of the final products can be predicted and whether to suspend the following semiconductor manufacturing process can immediately be determined to avoid wasting the manufacturing cost and time.

According to a first aspect of the present invention, a yield rate prediction method of a semiconductor manufacturing process is provided. The yield rate prediction method of the semiconductor manufacturing process includes the following steps. A correspondence relation between a circuit path of a netlist and an integrated circuit layout is established. Several defective points on several stacking layers are obtained. A recognition model is trained to recognize a fault occurred on the circuit path according to the defective points. A probability of the fault occurred on the circuit path of a semiconductor semi-final product is recognized for each of the stacking layers according to the recognition model. A yield rate of the semiconductor semi-final product is predicted according to the probability.

According to a second aspect of the present invention, a yield rate prediction system of a semiconductor manufacturing process is provided. The yield rate prediction system of the semiconductor manufacturing process includes a model training device and a prediction device. The model training device includes an establishment unit, a data acquisition unit and a machine learning unit. The establishment unit is configured to establish a correspondence relation between a circuit path of a netlist and an integrated circuit layout. The data acquisition unit is configured to obtain several defective points on several stacking layers. The machine learning unit is configured to train a recognition model to recognize a fault occurred on the circuit path according to the defective points. The prediction device includes a recognition unit and a prediction unit. The recognition unit is configured to recognize, for each of the stacking layers, a probability of the fault on the circuit path of a semiconductor semi-final product according to the recognition model. The prediction unit is configured to predict the yield rate of the semiconductor semi-final product according to the probability.

According to a third aspect of the present invention, a model training device is provided. The model training device includes an establishment unit, a data acquisition unit and a machine learning unit. The establishment unit is configured to establish a correspondence relation between a circuit path of a netlist and an integrated circuit layout. The data acquisition unit is configured to obtain several defective points on several stacking layers. The machine learning unit is configured to train a recognition model to recognize a fault occurred on the circuit path according to the defective points.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a yield rate prediction system of a semiconductor manufacturing process according to an embodiment.

FIG. 2 is a flowchart of a yield rate prediction method of a semiconductor manufacturing process according to an embodiment.

FIG. 3 is a schematic diagram of a netlist and an integrated circuit layout according to an embodiment.

FIG. 4 is a schematic diagram of a particular stacking layer of a semiconductor device according to an embodiment.

FIG. 5 is a schematic diagram of the positions of the defective points corresponding to the integrated circuit layout.

FIG. 6 is a schematic diagram illustrating the defective points causing a bridging fault.

FIG. 7 is a schematic diagram illustrating the defective points causing a stuck fault.

FIG. 8 is a schematic diagram illustrating the bridging fault or the stuck fault occurring at two adjacent stacking layers.

FIG. 9 illustrates a semiconductor semi-final product.

### DETAILED DESCRIPTION OF THE INVENTION

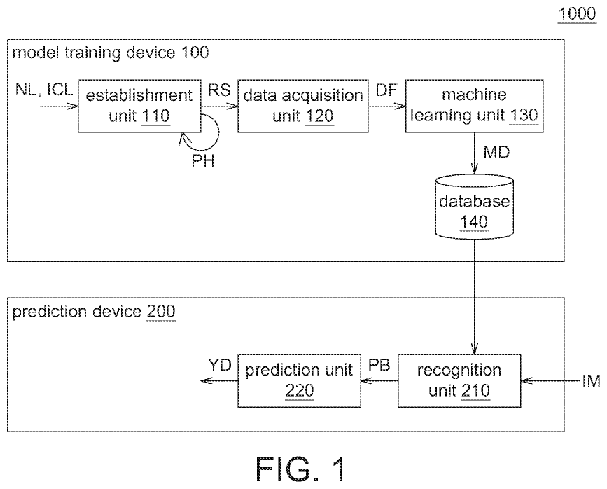

Referring to FIG. 1, a schematic diagram of a yield rate prediction system 1000 of a semiconductor manufacturing process according to an embodiment is shown. The yield rate prediction system 1000 includes a model training device 100 and a prediction device 200. The model training device 100 is configured to create a recognition model MD. The prediction device 200 is configured to predict the semiconductor manufacturing process using the recognition model MD. In the present embodiment, the recognition model MD recognizes semi-final products rather than final products in the semiconductor manufacturing process. Once defect occurs at any of the processes, the probability of the final products malfunctioning can immediately be predicted. Thus, the yield rate of the final products can be predicted, and whether to suspend the following semiconductor manufacturing process can also be immediately determined to avoid wasting the manufacturing time and cost.

The model training device 100 includes an establishment unit 110, a data acquisition unit 120, a machine learning unit 130 and a database 140. The prediction device 200 includes a recognition unit 210 and a prediction unit 220. The establishment unit 110, the data acquisition unit 120 and the machine learning unit 130, the recognition unit 210 and the prediction unit 220 can be realized by such as a circuit, chip, a circuit board, or a storage device storing programming codes. The database 140 can be realized such as a memory, a hard disc or a cloud storage center. Operations of each of the above elements are disclosed below with a flowchart.

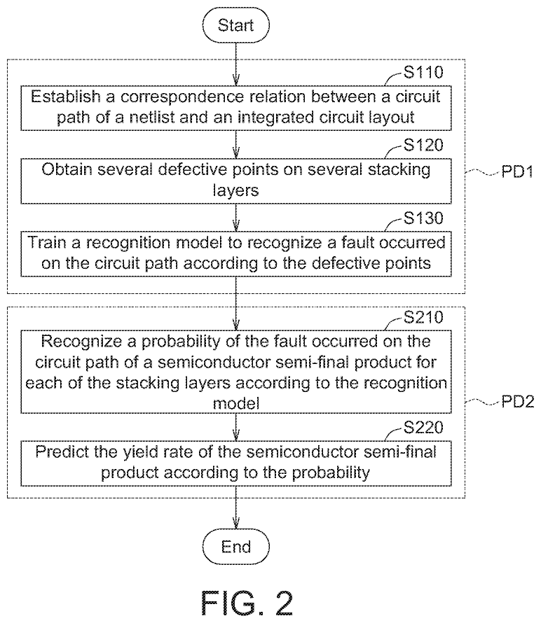

Referring to FIG. 2, a flowchart of a yield rate prediction method of a semiconductor manufacturing process according to an embodiment is shown. The yield rate prediction method of a semiconductor manufacturing process includes a model training procedure PD1 and a prediction procedure PD2. The model training procedure PD1 is a preceding or an off-line preparation procedure. Through the model training procedure PD1, the recognition model MD can be trained according to historical data. The prediction procedure PD2 is a real-time or an on-line execution procedure. Through the prediction procedure PD2, the recognition model MD can recognize the data collected in a real-time manner during the semiconductor manufacturing process to predict the yield rate of the final products.

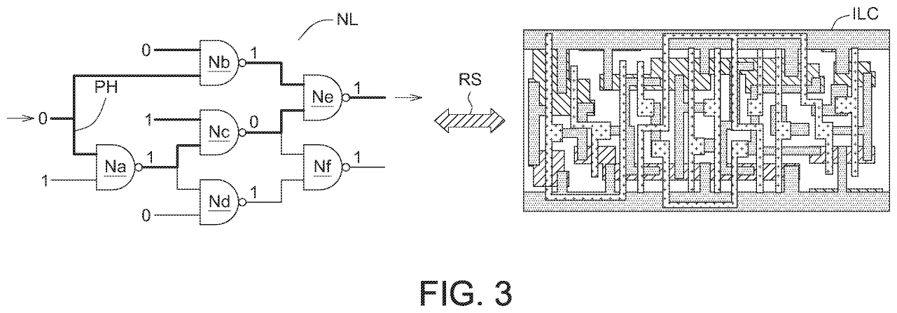

The model training procedure PD1 includes steps S110 to S130. Referring to FIG. 3, a schematic diagram of a netlist NL and an integrated circuit layout ICL according to an embodiment is shown. In step S110, a correspondence relation RS between a circuit path PH of a netlist NL and an integrated circuit layout ICL is established by the establishment unit 110. The netlist NL is also referred as a connection list. In the electronic automation design, the netlist NL describes the connection of digital circuits using basic logic gates. The netlist NL transfers the message of circuit connection, such as nets and related attributes of the modules.

As indicated in FIG. 3, the netlist NL includes NAND gates Na to Nf. When the “NAND gate Ne output error” occurs, it can be reversely inferred that a bridging fault or a stuck fault occurs on the circuit path PH (bolded part). The bridging fault is a fault caused by short-circuiting. The stuck fault, also referred as adhesive fault, is a fault which occurs when signals or pins are fixed at a high potential, a low potential, or a high resistance state.

As indicated in FIG. 3, the integrated circuit layout ICL describes the planar geometric shape of a physical integrated circuit. The integrated circuit layout ICL is a physical design of an integrated circuit. The physical design describes the layout of the netlist NL. The integrated circuit layout ICL includes the information of the shape, area and position of each hardware unit on the chip. In the integrated circuit layout ICL, different materials and stacking layers are represented by different colors. As indicated in FIG. 3, different materials and stacking layers are represented by different types of shading.

The establishment unit 110 can find corresponding hardware units in the netlist NL and the integrated circuit layout ICL. Therefore, the establishment unit 110 can establish a correspondence relation RS between the circuit path PH and the integrated circuit layout ICL. The correspondence relation RS describes the correspondence between the position, shape and area of each hardware unit on each stacking layer and the circuit path PH.

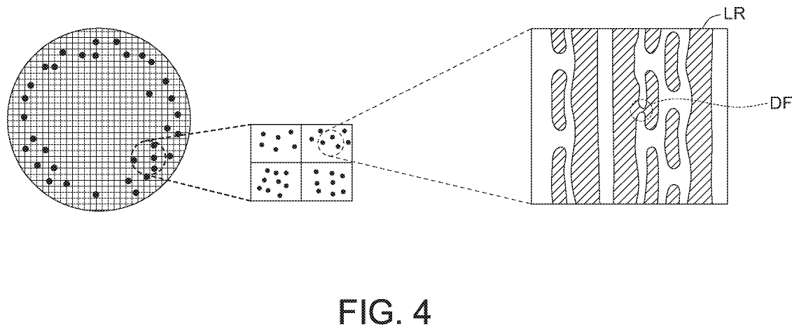

Then, the method proceeds to step S120, several defective points DF on several stacking layers LR are obtained by the data acquisition unit 120. Referring to FIG. 4, a schematic diagram of a particular stacking layer LR of a semiconductor device according to an embodiment is shown. As indicated in FIG. 4, during various wafer processes (such as etching, deposition, and polishing), each stacking layer LR is continuously detected using a scanning electron microscope (SEM), and is regarded as having a defective point DF if any hardware unit is detected to have a position shift or the area or shape of the hardware unit is not up to standard. The position, shape and area of each defective point DF are recorded. The defective points DF may or may not cause the final products to malfunction.

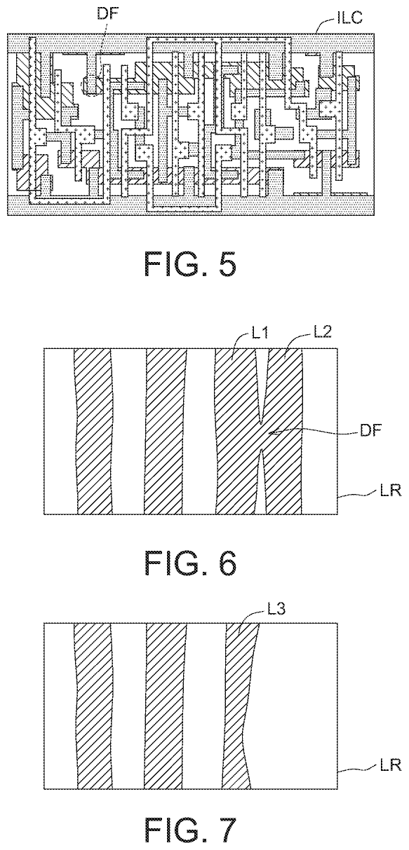

Referring to FIG. 5, a schematic diagram of the positions of the defective points DF corresponding to the integrated circuit layout ICL is shown. The integrated circuit layout ICL describes the design of multiple stacking layers LR (illustrated in FIG. 4). Any defective point DF on a particular stacking layer LR of FIG. 4 corresponds to a position on the integrated circuit layout ICL. As the process continues, all of the defective points DF detected on each stacking layer LR are recorded.

Then, the method proceeds to step S130, the recognition model MD is trained by the machine learning unit 130 to recognize a fault occurred on the circuit path PH according to the defective points DF. The defective points DF may cause two types of fault, namely, bridging fault and stuck fault, on the circuit path PH. The bridging fault or the stuck fault may occur at the same stacking layer LR. Referring to FIG. 6, a schematic diagram illustrating the defective points DF causing a bridging fault is shown. The defective point DF may result in a bridging fault; for example, two parallel metal lines L1 and L2 come into contact and become short-circuited. Referring to FIG. 7, a schematic diagram illustrating the defective points DF causing a stuck fault is shown. The defective point DF may result in a stuck fault; for example, the metal line L3 is too thin and generates an excessive impedance.

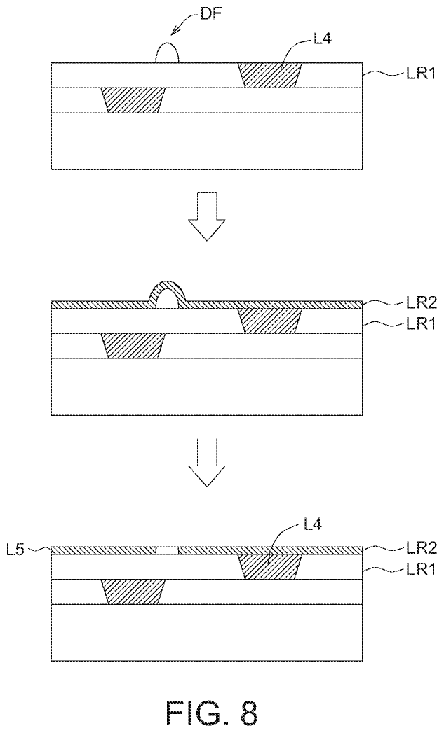

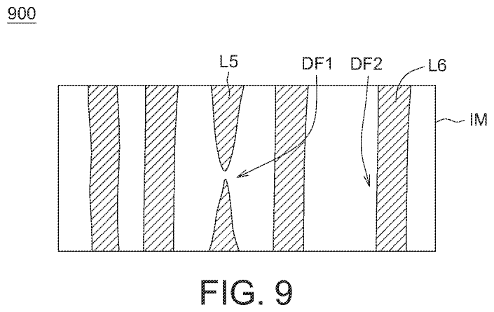

The bridging fault or the stuck fault may also occur at two adjacent stacking layers LR. Referring to FIG. 8, a schematic diagram illustrating the bridging fault or the stuck fault occurring at two adjacent stacking layers LR1 and LR2 is shown. The defective point DF caused by particles may fall at a particular position on the stacking layer LR1. The defective point DF does not fall on the metal line L4 of the stacking layer LR1, but causes the trace on the stacking layer LR2 to bulge and make the metal line L5 on the stacking layer LR2 broken and generate a stuck fault.

Therefore, the recognition model MD trained in step S130 can recognize the defective points DF, not only determining whether a fault may occur on the circuit path PH on the current stacking layer but further determining whether the fault may occur on the circuit path PH on a future stacking layer.

When a defective point DF is detected on a stacking layer LR, normally there is no telling whether the defective point DF will cause a fault on the circuit path PH. Normally, the fault on the circuit path PH can only be detected on a semiconductor final product. In the present embodiment, when a semiconductor final product is completed, each defective point DF on each stacking layer LR and each fault on the circuit path PH are recorded. The machine learning unit 130 can perform machine leaning, based on the information such as a sufficient amount of defective points DF and whether the defective points DF will cause fault on the circuit path PH, to train the recognition model MD. Once a defective point DF is detected on a semiconductor semi-final product, the recognition model MD can immediately determine whether the defective point DF may possibly cause fault on the circuit path PH without having to wait until all processes are completed.

In the present embodiment, the recognition model MD can be trained using a convolutional neural networks algorithm, a k-means clustering algorithm or a decision tree. The model training procedure PD1 can be completed through steps S110 to S130.

Then, the method proceeds to the prediction procedure PD2. The prediction procedure PD2 is a real-time or an on-line execution procedure. The prediction procedure PD2 includes steps S210 and S220. In step S210, a probability of the fault occurred on the circuit path PH of the semiconductor semi-final product for each of the stacking layers is recognized by the recognition unit 210 according to the recognition model MD. Referring to FIG. 9, a semiconductor semi-final product 900 is shown. An SEM image IM of the semiconductor semi-final product 900 is obtained using a scanning electron microscope (SEM), and the probability PB of the fault occurred on the circuit path PH can be analyzed by inputting the SEM image IM to the recognition model MD. As indicated in FIG. 9, the defective point DF1 is where the metal line L5 is broken. The defective point DF2 occurs when the metal line L6 is shifted and cannot be connected to a future conductive column. Since the recognition model MD has already learned various defective points which may possibly cause fault on the circuit path PH, there is no need to manually detect the defective points DF1 and DF2. Instead, the user only needs to input the SEM image IM to the recognition model MD, and the recognition model MD will analyze the probability PB of the fault occurred on the circuit path PH.

Additionally, manual detection can hardly detect the defective point DF2 which may cause fault on the circuit path PH. Through machine learning, the method of the present embodiment allows all defective points that may possibly cause fault on the circuit path PH to be detected earlier.

In step S220, a yield rate YD of the semiconductor semi-final product 900 is predicted by the prediction unit 220 according to the probability PB. The prediction unit 220 can summarize the probability PB of the fault occurred on the circuit path PH and predict the yield rate YD of the semiconductor semi-final product 900 being completed as a final product. If the predicted yield rate YD is too low, the prediction unit 220 can immediately determine whether to suspend the following process.

As disclosed in above embodiments, the recognition model MD recognizes semi-final products rather than final products during the semiconductor manufacturing process. Once defect occurs at any of the processes, the probability PB of the final products malfunctioning can immediately be predicted Thus, the yield rate YD of the final products can predict and immediately determine whether to suspend the following process to avoid wasting the time and cost of the semiconductor manufacturing process.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A yield rate prediction method of a semiconductor manufacturing process, comprising:
establishing a correspondence relation between a circuit path of a netlist and an integrated circuit layout;
obtaining a plurality of defective points on a plurality of stacking layers;
training a recognition model to recognize a fault occurred on the circuit path according to the defective points; and
recognizing, for each of the stacking layers, a probability of the fault occurred on the circuit path of a semiconductor semi-final product according to the recognition model; and
predicting a yield rate of the semiconductor semi-final product according to the probability.

2. The yield rate prediction method of the semiconductor manufacturing process according to claim 1, wherein the fault is a bridging fault or a stuck fault.

3. The yield rate prediction method of the semiconductor manufacturing process according to claim 2, wherein the bridging fault or the stuck fault occurs at one of the stacking layers.

4. The yield rate prediction method of the semiconductor manufacturing process according to claim 2, wherein the bridging fault or the stuck fault occurs at two adjacent layers of the stacking layers.

5. The yield rate prediction method of the semiconductor manufacturing process according to claim 1, wherein in the step of training the recognition model, the recognition model is trained to recognize the fault on the circuit path according to positions, shapes and areas of the defective points.

6. The yield rate prediction method of the semiconductor manufacturing process according to claim 1, wherein the step of recognizing the probability of the fault occurred on the circuit path is performed before the semiconductor manufacturing process of the semiconductor semi-final product is completed.

7. The yield rate prediction method of the semiconductor manufacturing process according to claim 1, wherein the step of predicting the yield rate of the semiconductor semi-final product is performed before the semiconductor manufacturing process of the semiconductor semi-final product is completed.

8. A yield rate prediction system of a semiconductor manufacturing process, comprising:
a model training device, comprising:
an establishment unit configured to establish a correspondence relation between a circuit path of a netlist and an integrated circuit layout;
a data acquisition unit configured to obtain a plurality of defective points on a plurality of stacking layers; and
a machine learning unit configured to train a recognition model to recognize a fault occurred on the circuit path according to the defective points; and
a prediction device, comprising:
a recognition unit configured to recognize, for each of the stacking layers, a probability of the fault occurred on the circuit path of a semiconductor semi-final product according to the recognition model; and
a prediction unit configured to predict a yield rate of the semiconductor semi-final product according to the probability.

9. The yield rate prediction system of the semiconductor manufacturing process according to claim 8, wherein the fault is a bridging fault or a stuck fault.

10. The yield rate prediction system of the semiconductor manufacturing process according to claim 9, wherein the bridging fault or the stuck fault occurs at one of the stacking layers.

11. The yield rate prediction system of the semiconductor manufacturing process according to claim 9, wherein the bridging fault or the stuck fault occurs at two adjacent layers of the stacking layers.

12. The yield rate prediction system of the semiconductor manufacturing process according to claim 8, wherein the training unit trains the recognition model to recognize the fault on the circuit path according to positions, shapes and areas of the defective points.

13. The yield rate prediction system of the semiconductor manufacturing process according to claim 8, wherein the recognition unit recognizes the probability of the fault occurred on the circuit path before the semiconductor manufacturing process of the semiconductor semi-final product is completed.

14. The yield rate prediction system of the semiconductor manufacturing process according to claim 8, wherein the prediction unit predicts the yield rate of the semiconductor semi-final product before the semiconductor manufacturing process of the semiconductor semi-final product is completed.

15. A model training device, comprising:
an establishment unit configured to establish a correspondence relation between a circuit path of a netlist and an integrated circuit layout;
a data acquisition unit configured to obtain a plurality of defective points on a plurality of stacking layers; and
a machine learning unit configured to train a recognition model to recognize a fault occurred on the circuit path according to the defective points.

16. The model training device according to claim 15, wherein the fault is a bridging fault or a stuck fault.

17. The model training device according to claim 16, wherein the bridging fault or the stuck fault occurs at one of the stacking layers.

18. The model training device according to claim 16, wherein the bridging fault or the stuck fault occurs at two adjacent layers of the stacking layers.

19. The model training device according to claim 15, wherein the training unit trains the recognition model to recognize the fault on the circuit path according to positions, shapes and areas of the defective points.
